(19) United States
(12) Patent Application Publication
(10) Pub. No.: US 2009/0115381 A1
(43) Pub. Date: May 7, 2009

(54) AUTOMATIC FREQUENCY CONTROL FOR SERIES RESONANT SWITCHED MODE POWER SUPPLY

(75) Inventor: Hendrik Jan ZWERVER, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,233

(22) PCT Filed: Jul. 14, 2005
(86) PCT No.: PCT/IB05/52348

§ 371 Date: Jan. 17, 2007

(30) Foreign Application Priority Data
Jul. 21, 2004 (EP) 04103466.1

(51) Int. Cl. G05F 1/00

(52) U.S. Cl. 323/271

(57) ABSTRACT

A switched mode power supply comprises a half bridge circuit or a full bridge circuit. A resonant circuit is connected to the bridge circuit and comprises an inductive element (105, 208): end a capacitive element (106, 209) connected in series, whereby the resonant circuit has a resonant frequency. The rate of change of a voltage across the resonant circuit is measured. A switching frequency of the switching elements is controlled for lowering the rate of change of the voltage across the resonant circuit to a predetermined minimum value. In ;:i no-load condition, the switching frequency of the switching elements is set to an operating frequency which is higher than the resonant frequency of the resonant circuit. In a load condition, the switching frequency of the switching elements is lowered to the resonant frequency of the resonant circuit.

The present invention relates to a switched mode power supply. More specifically, the invention relates to a series resonant switched mode power supply.

Switched mode power supplies which have an inductive load are known to have low switching losses, when the switch is turned on, due to zero voltage switching. On the other hand, switched mode power supplies which have a capacitive load are known to have the capability of low switching losses, when the switch is turned off, due to low current switching. As an example, LLC (inductor-inductor-capacitor) series resonant converters have low switching losses, since they have zero voltage switching as well as (almost) zero current switching, in particular when they are operating at the resonance frequency thereof In practice, power components like inductors and capacitors being part of the switched power supply have tolerances, and their electrical properties are not constant over time. Thus, the resonance frequency of the power circuit will not be stable. In addition, the oscillation frequency of the signal which is driving switching elements in the switched mode power supply will not be stable, since also the components being part of the driving circuitry are subject to variations, both from manufacture and from other external and internal influences. As a result, without additional measures the oscillation frequency of the driving circuit generally is not adapted to the resonance frequency of the power circuit, producing a sub-optimum operation of the switched mode power supply. If the oscillation frequency is higher than the resonance frequency, the switching elements will switch off more inductive current, resulting in increased switch turn-off losses. If the oscillation frequency is lower than the resonance frequency, the switching elements, inductors and other components will conduct an increased current, resulting in increased conduction losses.

In view of the above, there is a need for a control circuit for adapting the oscillation frequency to the resonance frequency in a simple and reliable way, thus minimizing switching losses.

In a first aspect of the present invention, this object is reached in a switched mode power supply according to claim 1.

When operating the switched mode power supply according to the invention at an operating frequency (i.e. the frequency at which the switching elements are operated) above the resonant frequency of the resonant circuit, a sine wave shaped resonant current (load current) is flowing in the resonant circuit at the moment of turn-off of the conducting switches. If the load circuit comprises a transformer coupled in series with the resonant circuit, the current to be switched off is the sine wave shaped load current (of which the magnitude is load-dependent) plus the magnetizing current of the transformer. The turning off of this composite current causes a rate of change (dV/dt) of the voltage across the resonant circuit which is steeper as the current to be switched off becomes larger (as the operating frequency is chosen higher). Thus, when the operating frequency is lowered from a frequency above the resonant frequency of the resonant circuit to a frequency approaching the resonant frequency, the rate of change of the voltage across the resonant circuit also decreases, and the switching elements of the bridge circuits will turn off a low current, which will only be the magnetizing current of a transformer connected in the resonant circuit, if the transformer is present, in case the operating frequency of the switches is at the resonant frequency of the resonant circuit. Controlling (i.e. varying) the frequency of the switching elements such as to reduce the rate of change of the voltage across the resonant circuit is advantageously used to operate the switching elements of the bridge circuit to reach the resonant frequency from a frequency above the resonant frequency. As a result, the power supply will, over its lifetime, operate in an optimum operating point, despite tolerances of resonant circuit components, and changes of electric properties of components over time. When operating the switching elements at the resonant frequency, the inductance of the transformer, if present, is compensated by the capacitance of the capacitor, resulting in a constant output voltage of the transformer under different loads. Further, the resonant circuit provides for a sinusoidal current through the transformer, if present, and thus decreases any losses in the transformer.

It is noted that the bridge circuit may be a half bridge circuit or a full bridge circuit.

It is further noted that the inductive element of the resonant circuit may be formed by the leakage inductance of a transformer, if the transformer is present. However, in addition to a transformer being part of the resonant circuit, the resonant circuit may comprise one or more additional inductive elements.

In the power supply according to the invention, if field effect transistors (FETs) are used as switching elements, zero voltage switching may be realized by using the magnetizing current to (dis)charge the drain-source capacitance of the FETs within a (possibly fixed) dead time between a first half of the bridge circuit conducting (where the second half does not conduct), and the second half of the bridge circuit conducting (where the first half does not conduct). When such a dead time is used, the resonance frequency calculated from the inductive and capacitive properties of the resonant circuit elements is lower than the actual resonance frequency. In this description, the actual resonance frequency, taking into account a possible dead time, is to be taken as the resonant frequency of the resonant circuit.

In a preferred embodiment, the control circuit is adapted for setting the switching frequency of the switching elements to an operating frequency higher than the resonant frequency of the resonant circuit at an essentially no-load condition; and lowering the switching frequency of the switching elements to the resonant frequency of the resonant circuit at a load condition.

In a no-load condition, if a transformer is present in the resonant circuit, the high switching frequency of the switching elements reduces the losses in the transformer core. As soon as a load is connected to the power supply, the high switching frequency leads to the resonant current (including the load current) to be switched off before its zero-crossing. This increases the rate of change of the voltage across the resonant circuit considerably. This signal is measured and, in the control circuit, is used to lower the switching frequency of the switching elements, thus also lowering the rate of change of the voltage until a predetermined minimum value is reached, at which the switching frequency of the switching elements corresponds to the resonant frequency of the resonant circuit. When the load is removed, the switching frequency of the switching elements is increased again to above the resonant frequency.

In a preferred embodiment, which is quite simple, the measuring circuit comprises a capacitor and a resistor connected in series. Such a differentiating circuit, when energized with the voltage across the resonant circuit, may provide a signal, such as a current, of the rate of change of the voltage. For further processing this signal in the control circuit, it may be rectified. The signal may also be buffered.

In another aspect of the invention, provision is made for a method for controlling the oscillation frequency of a switched mode power supply according to claim 4.

In yet another aspect of the invention, provision is made for a control circuit for a switched mode power supply according to claim 6.

The invention and its features, characteristics and advantages are further explained with reference to the accompanying drawings illustrating exemplary embodiments of the converter and some of its components. The embodiments are not to be taken as limiting the scope of the invention, but merely serve to clarify the broad aspects of the invention.

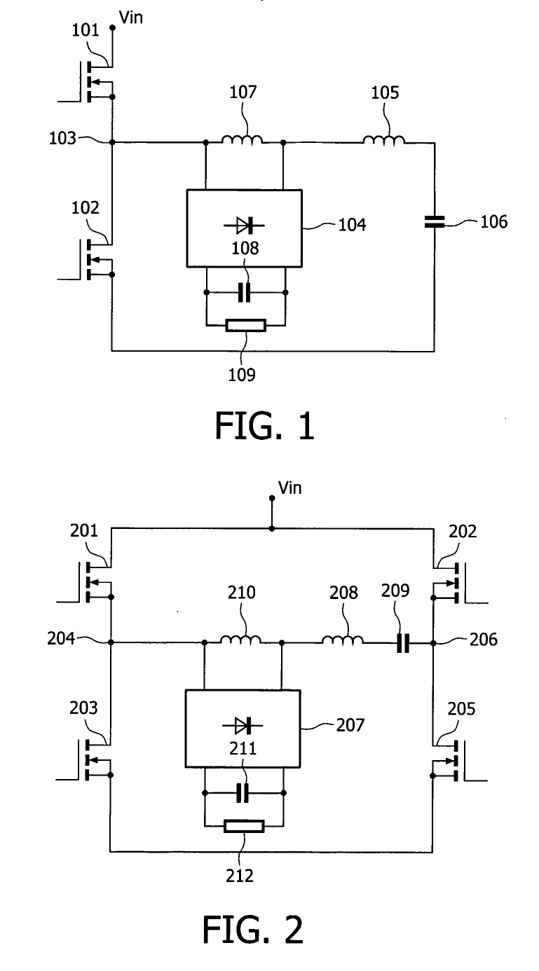

FIG. 1 shows a schematic diagram of a prior art series resonant half bridge LLC converter.

FIG. 2 shows a schematic diagram of a prior art series resonant full bridge LLC converter.

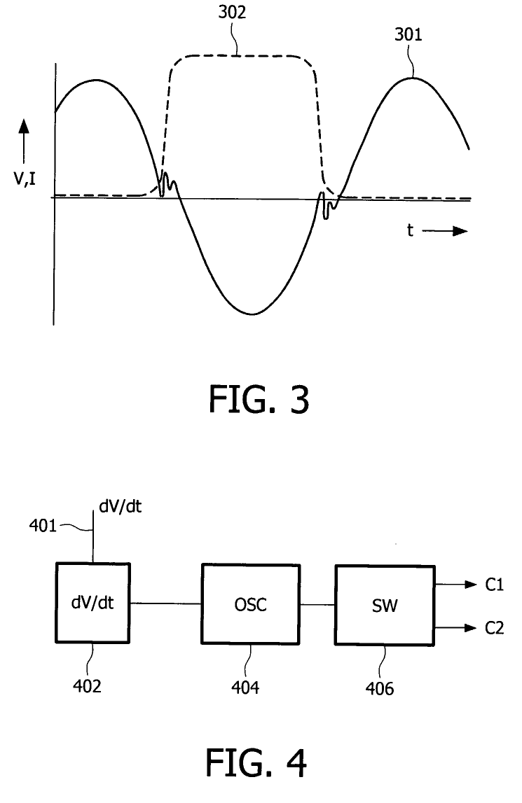

FIG. 3 shows waveforms of current through the switches and the voltage across. one switch in the converters of FIG. 1 or FIG. 2.

FIG. 4 shows a schematic diagram of a measuring and control circuit according to the present invention.

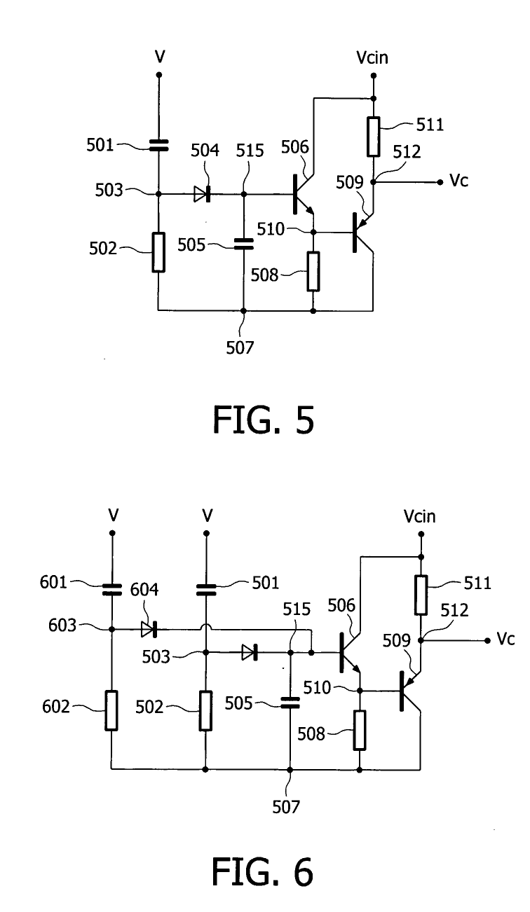

FIG. 5 shows a diagram of a measuring circuit according to the present invention for a half bridge converter.

FIG. 6 shows a diagram of a measuring circuit according to the present invention for a full bridge converter.

In the drawings, the same reference numerals indicate the same components or components having the same or similar function.

FIG. 1 shows an example of a half bridge LLC converter circuit. A first terminal of a first switching element 101 is connected to a DC supply voltage Vin. A second terminal of the first switching element 101 is connected to a first terminal of a second switching element 102 through a node 103. The switching elements 101, 102 are represented in FIG. 1 as solid state switches, in particular MOSFETs, more in particular N-type MOSFETs, but may take any other suitable form. The node 103 is connected to a second terminal of the second switching element 102 through a series connection of an input of a rectifier 104, an inductor 105 and a capacitor 106. An inductor 107 shown connected in parallel with the rectifier 104 may represent an actual inductor, or may represent the magnetizing inductance of a transformer being part of the rectifier 104. If the rectifier 104 does not comprise a transformer, then the inductor 107 may be absent. If present, the inductor 107 promotes zero voltage switching. The inductance of the inductor 107 is much larger than the inductance of the inductor 105, so that a resonance frequency of the circuit connected between the second terminal of the second switching element 102 and the node 103 essentially is determined by the inductor 105 and the capacitor 106, which form a resonant circuit. However, the resonant circuit may also be formed by inductor 107 and capacitor 106, if the inductor 105 is absent.

At an output of the rectifier 104, a buffer capacitor 108 is shown connected in parallel with a load 109.

FIG. 2 shows an example of a full bridge LLC converter circuit. A first terminal of a first switching element 201 and a first terminal of a second switching element 202 are connected to a DC supply voltage Vin. The second terminal of the first switching element 201 is connected to a first terminal of a third switching element 203 through a node 204. The second terminal of the second switching element 202 is connected to a first terminal of a fourth switching element 205 through a node 206. The second terminal of the third switching element 203 is connected to the second terminal of the fourth switching element 205. The switching elements 201, 202, 203 and 205 are represented as solid state switches, in particular MOSFETs, more in particular N-type MOSFETs, but may take any other suitable form. The nodes 204 and 206 are connected to each other through a series connection of an input of a rectifier 207, an inductor 208 and a capacitor 209. An inductor 210 shown connected in parallel with the rectifier 207 may represent an actual inductor, or may represent the magnetizing inductance of a transformer being part of the rectifier 207. If the rectifier 207 does not comprise a transformer, then the inductor 210 may be absent. If present, the inductor 210 promotes zero voltage switching. The inductance of the inductor 210 is much larger than the inductance of the inductor 208, so that a resonance frequency of the circuit connected between the nodes 204 and 206 essentially is determined by the inductor 208 and the capacitor 209, which form a resonant circuit. However, the resonant circuit may also be formed by inductor 210 and capacitor 209, if the inductor 208 is absent.

At an output of the rectifier 207, a buffer capacitor 211 is shown connected in parallel with a load 212.

FIG. 3 shows a waveform (essentially sine wave) of a current 301 (solid line) through one of the switching elements 101, 102 (FIG. 1) or 201, 202, 203, 205 (FIG. 2), and a waveform (essentially block wave) of a voltage 302 (broken line) across one of the switching elements 101, 102, 201, 202, 203 or 205. From these waveforms, it is clear that during turning on and turning off of the switching elements, essentially no current and no voltage are handled by the switching elements. The only current which is switched off is a current generated by magnetizing the transformer.

Now, if the switching elements of the bridge circuit of FIG. 1 or 2 are switched at a higher frequency than the resonance frequency of the resonant circuit, then the switching element(s) turning off will switch a higher current off than shown in FIG. 3, resulting in a higher dV/dt (rate of change of the voltage across the resonant circuit). According to the invention, the dV/dt is measured, and the increase of the dV/dt will, in a control circuit, be converted into a decrease of the switching frequency, thus lowering the dV/dt, and adapting the switching frequency to the resonance frequency of the resonant circuit.

FIG. 4 shows a control circuit for the power circuit of FIG. 1, the control circuit being connected to a dV/dt measuring circuit 402 having an input 401 connected to node 103 of the bridge circuit of FIG. 1. Exemplary embodiments of the dV/dt measuring circuit 402 are explained below with reference to FIGS. 5 and 6. The control circuit comprises an oscillator section (OSC) 404 coupled to the measuring circuit 402, and a switching signal generating section (SW) 406 coupled to the oscillator section 404. A signal with a frequency generated in the oscillator section is converted into switching signals c1, c2 for the (bases of the) switching elements 101, 102 in the switching signal generating section 406.

The oscillator section 404 may comprise a section introducing a dead time in between the switching of the different switching elements, in order to enable (in case of MOSFETs being used as switching elements) the drain-source capacitance to be (dis)charged by the magnetizing current of the transformer.

The measuring circuit 402 of FIG. 4 receives a voltage signal from the node 103 of the power supply circuit of FIG. 1. The measuring circuit 402 provides an output signal (preferably a current) which is proportional to the dV/dt of the voltage signal. The measuring circuit output signal is supplied to the oscillator section 404 comprising an oscillator with a frequency depending from the output signal of the measuring circuit 402, such that if the measuring circuit output signal increases, the oscillator frequency decreases. Such oscillators are known in the art, and therefore further details of the oscillator are omitted here. As a consequence of the oscillator frequency decreasing, also the frequency of the switching signals for the switching elements 101, 102 decreases. If the switching signal frequency decreases, the dV/dt measured by the measuring circuit 402 decreases. Thus, the dV/dt may be stabilized by the control circuit.

If the circuit of FIG. 4 is to be coupled to the full bridge circuit of FIG. 2, then two inputs instead of one input to the measuring circuit 402 are provided, and four instead of two switching signals c1, c2 are provided.

FIG. 5 shows an exemplary embodiment of a dV/dt measuring circuit 402 as indicated in FIG. 4. According to FIG. 5, the measuring circuit comprises a small capacitor 501 having a first terminal thereof connected to a first terminal of a resistor 502, thus forming a node 503. The second terminal of the capacitor 501 is connected to the node 103 of FIG. 1 for measuring a voltage V being generated there. The node 503 further is connected to the anode of a diode 504, the cathode of which is connected to a first terminal of a capacitor 505, and the base of a first transistor 506 in a node 515. The second terminal of the capacitor 505 and the second terminal of the resistor 502 are connected to a node 507. The emitter of the first transistor 506, the first terminal of a resistor 508, and the base of a second transistor 509 are connected to a node 510. The second terminal of the resistor 508 and the collector of the second transistor 509 are connected to the node 507. The collector of the first transistor 506 and a first terminal of a resistor 511 are supplied with a DC supply voltage Vcin. The second terminal of the resistor 511 is connected to the emitter of the second transistor 509 through a node 512. The node 512 provides a DC control signal (output current) Vc.

If the measuring circuit is to be used in a full bridge circuit (FIG. 2), the diagram of FIG. 6 applies. The partial circuit formed by capacitor 501, resistor 502, node 503, and diode 504 have been duplicated by capacitor 601, resistor 602, node 603, and diode 604 to provide a second terminal of the capacitor 601. The second terminals of the capacitors 501 and 601 are to be connected to the respective nodes 204 and 206 of FIG. 2 for measuring a voltage being generated there.

The measuring devices of FIGS. 5 and 6 operate as follows. At the node 503 (FIG. 5) or the nodes 503, 603, respectively (FIG. 6), a voltage is generated across the resistor 502 (FIG. 5) or the resistors 502, 602, respectively (FIG. 6), by the current generated by the capacitor 501 (FIG. 5) or the currents generated by the capacitors 501, 601, respectively (FIG. 6), being proportional to the dV/dt across the capacitor 501 (FIG. 5) or the capacitors 501, 601, respectively (FIG. 6). This generated voltage is single-sided rectified by the diode 504 (FIG. 5) or the diodes 504, 604, respectively (FIG. 6), and buffered by the capacitor 505 (FIGS. 5 and 6). The voltage across the capacitor 505 is directly proportional to the voltage of the node 512, such that the signal Vc is directly proportional to the dV/dt generated in the bridge circuit.

While the invention has been described and illustrated in its preferred embodiments, it should be understood that departures may be made therefrom within the scope of the invention, which is not limited to the details disclosed herein. Further, in the above description as well as in the appended claims, ‘comprising’ is to be understood as not excluding other elements or steps, and ‘a’ or ‘an’ does not exclude a plurality. Still further, any reference signs in the claims shall not be construed as limiting the scope of the invention.

1. Switched mode power supply, comprising:
a bridge circuit comprising at least two switching elements (101, 102; 201, 203, 202, 205) connected in series;
a resonant circuit connected to the bridge circuit and comprising an inductive element (105) and a capacitive element (106) connected in series, the resonant circuit having a resonant frequency;
a control circuit for controlling the switching of the switching elements; and
a measuring circuit (402) for measuring a parameter in the bridge circuit, the measuring circuit providing a measuring signal to the control circuit,
wherein the measuring circuit is adapted for measuring a rate of change of the voltage across the resonant circuit, and wherein the control circuit is adapted for controlling a switching frequency of the switching elements for lowering the rate of change of the voltage across the resonant circuit to a predetermined minimum value.

2. Switched mode power supply according to claim 1, wherein the control circuit is adapted for:
setting the switching frequency of the switching elements (101, 102; 201, 202, 203, 205) to an operating frequency higher than the resonant frequency of the resonant circuit at an essentially no-load condition; and
lowering the switching frequency of the switching elements to the resonant frequency of the resonant circuit at a load condition.

3. Switched mode power supply according to claim 1, wherein the measuring circuit (402) comprises a capacitor (501, 601) and a resistor (502, 602) connected in series.

4. Method for controlling the oscillation frequency of a switched mode power supply comprising a bridge circuit with at least two switching elements connected in series, and a resonant circuit connected to the bridge circuit and comprising an inductive element and a capacitive element connected in series, the resonant circuit having a resonant frequency, the method comprising:
(a) measuring a rate of change of a voltage across the resonant circuit; and
(b) controlling a switching frequency of the switching elements for lowering the rate of change of the voltage across the resonant circuit to a predetermined minimum value.

5. Method according to claim 4, wherein step (b) comprises:
setting the switching frequency of the switching elements to an operating frequency higher than the resonant frequency of the resonant circuit at an essentially no-load condition; and
lowering the switching frequency of the switching elements to the resonant frequency of the resonant circuit at a load condition.

6. Control circuit for a switched mode power supply comprising a bridge circuit with at least two switching elements connected in series, and a resonant circuit connected to the bridge circuit and comprising an inductive element and a capacitive element connected in series, the resonant circuit having a resonant frequency, the control circuit comprising:
an input receiving a signal indicating a rate of change of a voltage across the resonant circuit; and
switching signal outputs for switching the switching elements;
wherein the control circuit is adapted for controlling a switching frequency of the switching elements for lowering the rate of change of the voltage across the resonant circuit to a predetermined minimum value.

7. Control circuit according to claim 6, wherein the control circuit is adapted for:
setting the switching frequency of the switching elements to an operating frequency higher than the resonant frequency of the resonant circuit at an essentially no-load condition; and
lowering the switching frequency of the switching elements to the resonant frequency of the resonant circuit at a load condition.
